(19) United States
(12) Patent Application Publication
(10) Pub. No.: US 2017/0095756 A1
(43) Pub. Date: Apr. 6, 2017

(54) Oil Filter Assembly

(71) Applicant: Peter Abela, Syosset, NY (US)

(72) Inventor: Peter Abela, Syosset, NY (US)

(21) Appl. No.: 14/872,261

(22) Filed: Oct. 1, 2015

(51) Int. Cl. B01D 35/00; B01D 35/30

(52) U.S. Cl. CPC B01D 35/005; B01D 35/306

(57) ABSTRACT

An oil filter assembly includes an oil filter that may be fluidly coupled to an internal combustion engine thereby facilitating the oil filter to filter oil within the internal combustion engine. A cap is removably coupled to the oil filter. The cap inhibits the oil from spilling from the oil filter when the oil filter is removed from the internal combustion engine. A drain is removably coupled to the oil filter. The drain facilitates the oil to be drained from the oil filter after the oil filter is removed from the internal combustion engine.

### BACKGROUND OF THE DISCLOSURE

### Field of the Disclosure

The disclosure relates to filter devices and more particularly pertains to a new filter device for inhibiting oil from spilling from an oil filter.

### SUMMARY OF THE DISCLOSURE

An embodiment of the disclosure meets the needs presented above by generally comprising an oil filter that may be fluidly coupled to an internal combustion engine thereby facilitating the oil filter to filter oil within the internal combustion engine.

A cap is removably coupled to the oil filter. The cap inhibits the oil from spilling from the oil filter when the oil filter is removed from the internal combustion engine. A drain is removably coupled to the oil filter. The drain facilitates the oil to be drained from the oil filter after the oil filter is removed from the internal combustion engine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom perspective view of an oil filter assembly according to an embodiment of the disclosure.

FIG. 2 is a front view of an embodiment of the disclosure.

FIG. 3 is a bottom view of an embodiment of the disclosure.

FIG. 4 is a top view of an embodiment of the disclosure.

FIG. 5 is an exploded perspective view of an embodiment of the disclosure.

### DESCRIPTION OF THE PREFERRED EMBODIMENT

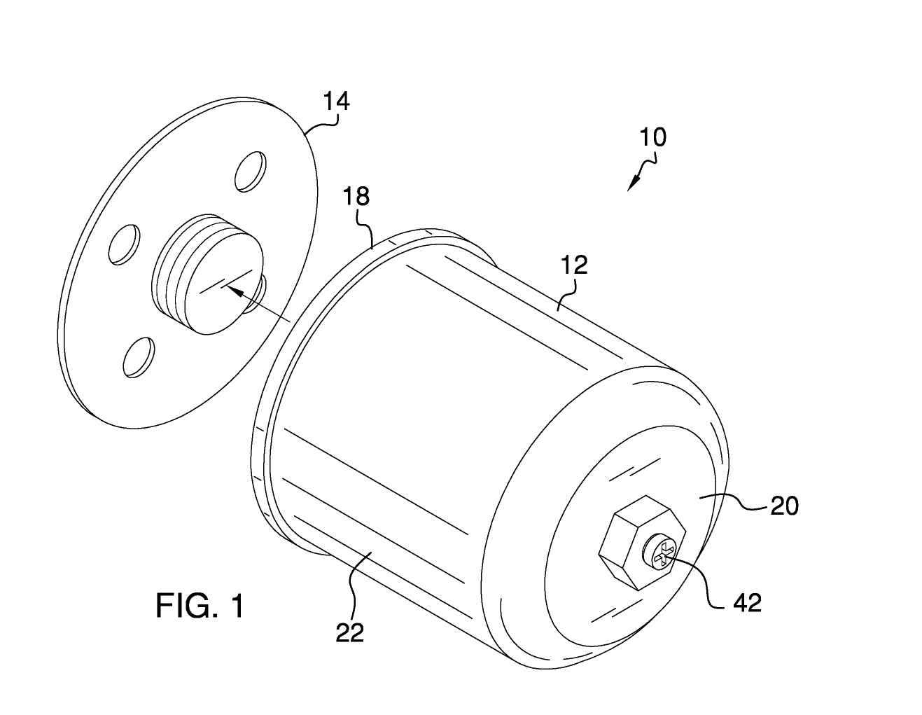

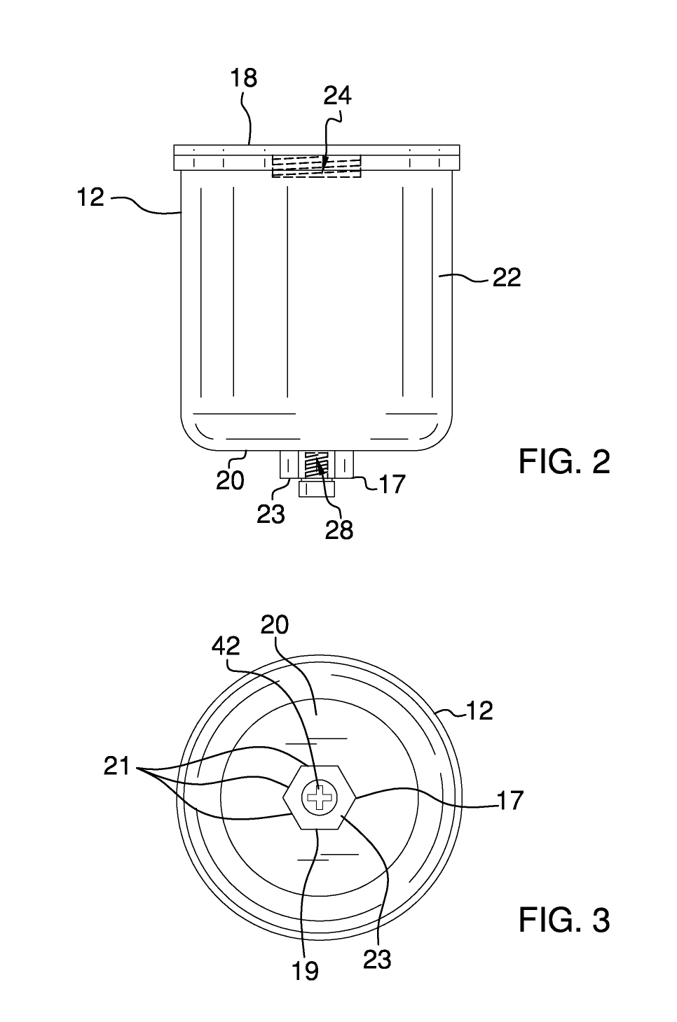

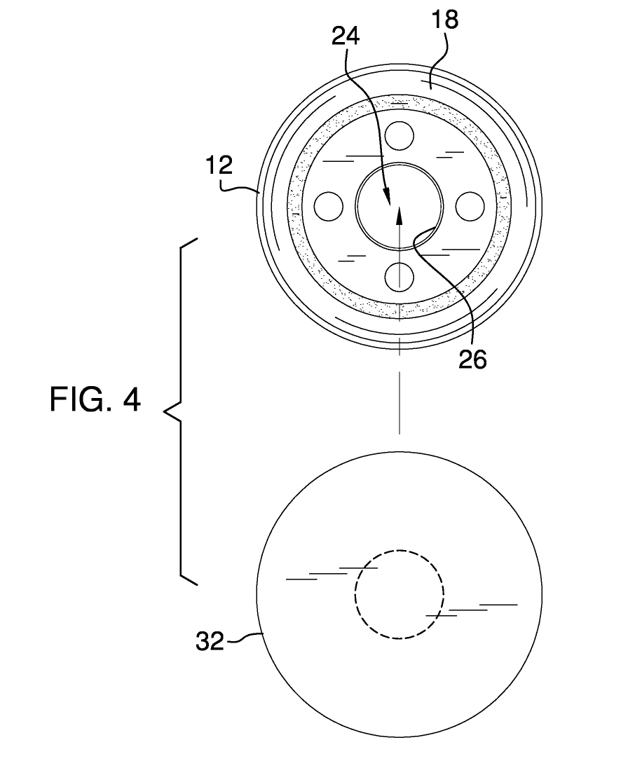

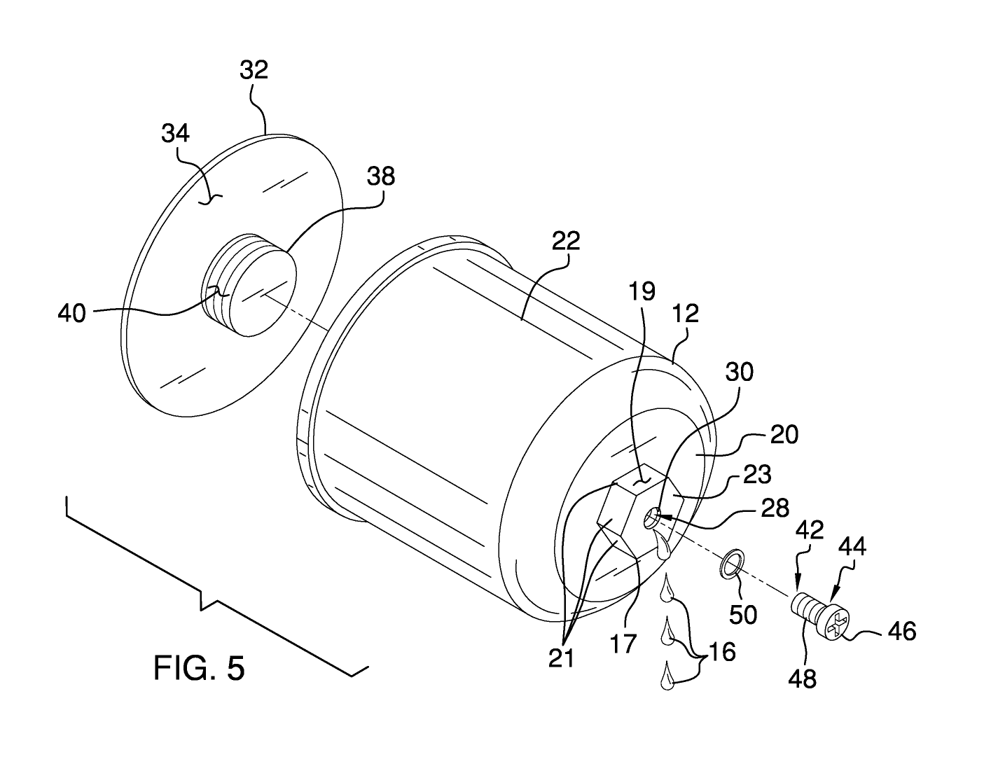

With reference now to the drawings, and in particular to FIGS. 1 through 5 thereof, a new filter device embodying the principles and concepts of an embodiment of the disclosure and generally designated by the reference numeral 10 will be described.

As best illustrated in FIGS. 1 through 5, the oil filter assembly 10 generally comprises an oil filter 12 that may be fluidly coupled to an internal combustion engine 14. The oil filter 12 filters oil 16 within the internal combustion engine 14. The oil filter 12 may filter the oil 16 through any conventional means of filtering oil 16 in an internal combustion engine 14. The internal combustion engine 14 may be a diesel engine, a gasoline engine or any other internal combustion engine 14.

The oil filter 12 has a top end 18, a bottom end 20 and a peripheral wall 22 extending between the top end 18 and the bottom end 20. The peripheral wall 22 is curved such that the oil filter 12 has a cylindrical shape. The bottom end 20 has a raised portion 17 and the raised portion 17 has an exterior surface 19. The exterior surface 19 has a plurality of intersecting sides 21 and the intersecting sides 21 forms a plurality of wrench faces. Thus, the raised portion 17 may be gripped by a wrench thereby facilitating the oil filter 12 to be removed from the internal combustion engine 14.

The raised portion 17 has a distal end 23 with respect to the bottom end 20. The top end 18 has a first opening 24 extending therethrough. The first opening 24 has a bounding edge 26. The distal end 23 has a second opening 28 extending into the oil filter 12 and the second opening 28 has a bounding edge 30.

A cap 32 is removably coupled to the oil filter 12 and the cap 32 inhibits the oil 16 from spilling from the oil filter 12 when the oil filter 12 is removed from the internal combustion engine 14. The cap 32 has a bottom surface 34 and the cap 32 includes a coupler 38 extending downwardly from the bottom surface 34. The coupler 38 has an outer surface 40. The outer surface 40 is threaded such that the outer surface 40 threadably engages the bounding edge 26 corresponding to the first opening 24. The bottom surface 34 abuts the top end 18 when the cap 32 is coupled to the oil filter 12. Thus, the cap 32 closes the first opening 24 thereby inhibiting the oil 16 from leaking from the first opening 24 when the oil filter 12 is removed from the internal combustion engine 14.

A drain 42 is removably coupled to the oil filter 12. The drain 42 facilitates the oil 16 to be drained from the oil filter 12 after the oil filter 12 is removed from the internal combustion engine 14. Thus, the drain 42 reduces an amount of oil 16 that may potentially spill from the oil filter 12 when the oil filter 12 is removed from the internal combustion engine 14. The oil 16 may be engine oil of any conventional design.

The drain 42 comprises a screw 44 that has a shaft 46 and a head 48. The shaft 46 threadably engages the bounding edge 30 corresponding to the second opening 28. A gasket 50 is positioned around the shaft 46. The gasket 50 is compressed between the bottom end 20 and the head 48 when the screw 44 is threaded into the second opening 28. Thus, the gasket 50 inhibits the oil 16 from leaking outwardly from the second opening 28.

In use, the oil filter 12 is removed from the internal combustion engine 14 when the oil filter 12 is to be replaced. The cap 32 is coupled to the oil filter 12 thereby inhibiting the oil 16 to spill from the oil filter 12. The drain 42 is removed from the oil filter 12 after the cap 32 is coupled to the oil filter 12. The drain 42 facilitates the oil 16 to be drained from the oil filter 12 at a desired time and at a desired location. Additionally, the drain 42 facilitates the oil 16 to be drained in a controlled fashion thereby reducing the likelihood of spilling the oil 16 in an undesired location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An oil filter assembly comprising:
An oil filter being configured to be fluidly coupled to an internal combustion engine thereby facilitating said oil filter to filter oil within the internal combustion engine;
a cap being removably coupled to said oil filter wherein said cap is configured to inhibit the oil from spilling from said oil filter when said oil filter is removed from the internal combustion engine; and
a drain being removably coupled to said oil filter wherein said drain is configured to facilitate the oil to be drained from said oil filter after said oil filter is removed from the internal combustion engine.

2. The assembly according to claim 1, wherein said oil filter has a top end, a bottom end and a peripheral wall extending between said top end and said bottom end, said peripheral wall being curved such that said oil filter has a cylindrical shape, said bottom end having a raised portion, said raised portion having an exterior surface, said exterior surface having a plurality of intersecting sides such that said intersecting sides forms a plurality of wrench faces wherein said raised portion is configured to be gripped by a wrench thereby facilitating said oil filter to be removed from the internal combustion engine, said raised portion having a distal end with respect to said bottom end.

3. The assembly according to claim 2, wherein said top end has a first opening extending therethrough, said first opening having a bounding edge.

4. The assembly according to claim 2, wherein said distal end has a second opening extending into said oil filter, said second opening having a bounding edge.

5. The assembly according to claim 1, wherein said cap has a bottom surface, said cap including a coupler extending downwardly from said bottom surface, said coupler having an outer surface.

6. The assembly according to claim 5, wherein:
said oil filter has a top end and a first opening, said first opening having a bounding edge; and
said outer surface being threaded such that said outer surface threadably engages said bounding edge corresponding to said first opening having said bottom surface abutting said top end.

7. The assembly according to claim 1, wherein:
said oil filter has a second opening, said second opening having a bounding edge; and
said drain comprises a screw having a shaft and a head, said shaft threadably engaging said bounding edge corresponding to said second opening.

8. The assembly according to claim 7, wherein:
said oil filter has a bottom end; and
a gasket being positioned around said shaft, said gasket being compressed between said bottom end and said head when said screw is threaded into said second opening wherein said gasket is configured to inhibit the oil from leaking outwardly from said second opening.

9. An oil filter assembly comprising:
An oil filter being configured to be fluidly coupled to an internal combustion engine thereby facilitating said oil filter to filter oil within the internal combustion engine, said oil filter having a top end, a bottom end and a peripheral wall extending between said top end and said bottom end, said peripheral wall being curved such that said oil filter has a cylindrical shape, said bottom end having a raised portion, said raised portion having an exterior surface, said exterior surface having a plurality of intersecting sides such that said intersecting sides forms a plurality of wrench faces wherein said raised portion is configured to be gripped by a wrench thereby facilitating said oil filter to be removed from the internal combustion engine, said raised portion having a distal end with respect to said bottom end, said top end having a first opening extending therethrough, said first opening having a bounding edge, said distal end having a second opening extending into said oil filter, said second opening having a bounding edge;
a cap being removably coupled to said oil filter wherein said cap is configured to inhibit the oil from spilling from said oil filter when said oil filter is removed from the internal combustion engine, said cap having a bottom surface, said cap including a coupler extending downwardly from said bottom surface, said coupler having an outer surface, said outer surface being threaded such that said outer surface threadably engages said bounding edge corresponding to said first opening having said bottom surface abutting said top end; and
a drain being removably coupled to said oil filter wherein said drain is configured to facilitate the oil to be drained from said oil filter after said oil filter is removed from the internal combustion engine, said drain comprising:
a screw having a shaft and a head, said shaft threadably engaging said bounding edge corresponding to said second opening, and
a gasket being positioned around said shaft, said gasket being compressed between said bottom end and said head when said screw is threaded into said second opening wherein said gasket is configured to inhibit the oil from leaking outwardly from said second opening.
